(19) United States
(12) Patent Application Publication
(10) Pub. No.: US 2019/0338729 A1
(43) Pub. Date: Nov. 7, 2019

(54) THROTTLE RETURN SPRING DEVICE, A KIT COMPRISING THE DEVICE, AND A METHOD OF INSTALLING THEREOF

(71) Applicant: David Leonard Hays, JR., Brentwood, CA (US)

(72) Inventor: David Leonard Hays, JR., Brentwood, CA (US)

(21) Appl. No.: 16/403,431

(22) Filed: May 3, 2019

Related U.S. Application Data
(60) Provisional application No. 62/667,375, filed on May 4, 2018.

(51) Int. Cl. F02M 19/12; F02D 9/08

(52) U.S. Cl. CPC F02M 19/128; F02D 2009/0269; F02D 9/08

(57) ABSTRACT

A coil-over throttle return spring device mounts onto the exterior of the carburetor and allows the user to adjust the throttle tension without having to remove the device from the carburetor. The throttle tension is adjusted by moving the ring along the length of the body to lengthen or shorten the spring. A coil-over throttle return spring device kit comprises the device and a bracket and hardware used to easily mount onto various size carburetors. The bracket and hardware allows for adjustability depending on the size of the engine and length of cables. A method of installing a coil-over throttle return spring device kit onto a carburetor and a method of adjusting the throttle tension.

### CROSS-REFERENCE TO RELATED APPLICATION

This application claims the benefit of U.S. Provisional Application No. 62/667,375 filed May 4, 2018, which is hereby incorporated by reference in its entirety.

### FIELD OF THE INVENTION

This present invention generally relates to automotive/motorsports, and more particularly to throttle return spring systems.

### BACKGROUND

Since the invention of the carburetor, a pull-type throttle spring system comprising an extension spring has been used to operate the throttle return. With this mechanism, through the mechanics of an engine, the spring has to pull to operate the throttle return system. As such, the extension spring is changed repeatedly to obtain the desired throttle tension because there are spring in different lengths and wire diameters. In addition, if the spring fatigues during use and breaks, the spring simply falls off and the breakage causes a failure in the throttle return system. As a result, the gas pedal no longer returns to its resting position. The pull-type throttle spring system is cumbersome in design and function and has no provisions in the event of spring failure. In addition, when the pull-type throttle spring system comprising the extension spring is in a resting position, it is pulling on the throttle shaft bushing, which wears down the throttle shaft bushing.

The appearance of the current/traditional pull-type throttle spring system is also unattractive as it looks much like a spring used to close a screen door or a fence, which is not very becoming on a chromed hot rod engine. For automobiles such as hot rods, appearance is paramount and there is no other throttle spring system that is alluring to the eye.

As such, there is a need for an improved performance, safer and more attractive throttle spring system.

### SUMMARY

The present application describes a universal throttle return spring system that attaches to a carburetor and utilizes an adjustable shock to fine tune throttle tension.

In some embodiments, the adjustable throttle return spring comprises a rod connected to a threaded shock body, a spring surrounding the rod and threaded shock body, an adjuster ring around the threaded shock body and two mounting ends.

In some embodiments, the billet coil-over throttle return spring kit comprises a bracket, shock body, spring, spacers/bushings, and mounting hardware.

In some embodiments, the coil-over throttle return spring kit comprises a bracket, shock body, spring, spacers/bushings, and mounting hardware.

In some embodiments, the billet coil-over throttle return spring kit comprises a bracket made of 6061 T6 billet aluminum, shock body made of 6061 billet aluminum, spring steel, aluminum spacers/bushings, mounting hardware made of 18-8 stainless steel.

In some embodiments, the coil-over throttle return spring kit comprises a bracket made of 6061 T6 billet aluminum, shock body made of 6061 billet aluminum, spring steel, aluminum spacers/bushings, mounting hardware made of 18-8 stainless steel.

In some embodiments, there is a method of installing a coil-over throttle return spring device kit, the kit comprising a throttle return spring device with a first mounting end and a second mounting end and a body located between the first mounting end and the second mounting end and coaxially surrounding the rod. There is an adjuster ring surrounding the body and configured to threadedly rotate along a length of the body and a throttle spring coaxially surrounding the body and rod and loaded between the adjuster ring and a cap. There is a bracket for attaching the first mounting end to an intake manifold of an engine, the bracket comprising a platform having an upperside and a lower side and an opening and the method of installing the coil-over throttle return spring device kit comprising: removing a bolt from the intake manifold, mounting the platform to the intake manifold by securing the bolt through the opening, mounting the first mounting end to the platform and mounting the second mounting end to a throttle arm.

An object of the present invention is to have a billet coil-over throttle return spring use compression to operate the throttle system, according to an embodiment.

An object of the present invention is to have a self-contained unit with no springs to change, according to an embodiment.

Another object of the present invention is to easily change the tension of the spring by adjusting the adjuster ring around the shock body, according to an embodiment.

A further object of the present invention is to have a safer throttle spring system by capturing the spring in the shock body, so if the system fails, the throttle return remains operational, according to an embodiment.

These features, advantages and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 illustrates the adjustable throttle return spring kit, according to an embodiment of the present invention.

FIG. 2 illustrates the platform, according to an embodiment of the present invention.

FIG. 3 illustrates another view of the platform removably attached to the throttle cable tab, according to an embodiment of the present invention.

FIG. 4 illustrates the transmission kick down tab with hardware, according to an embodiment of the present invention.

FIG. 5 illustrates a top, front, outer side perspective view of the adjustable throttle return spring and bracket mounted to a carburetor, according to an embodiment of the present invention.

FIG. 6 illustrates a top, rear, inner side perspective view of the adjustable throttle return spring and bracket mounted to a carburetor, according to an embodiment of the present invention.

FIG. 7 illustrates a top, outer side perspective view of the adjustable throttle return spring and bracket mounted to a carburetor, according to an embodiment of the present invention.

FIG. 8 illustrates yet another bottom perspective view of the adjustable throttle return spring and bracket mounted to a carburetor, according to an embodiment of the present invention.

FIG. 9 illustrates a top perspective view of the adjustable throttle return spring and bracket mounted to a carburetor, according to an embodiment of the present invention.

FIG. 10 illustrates a rear perspective view of the adjustable throttle return spring and bracket mounted to a carburetor, according to an embodiment of the present invention.

FIGS. 11A-11D illustrates a method of mounting the adjustable throttle return spring and bracket to a carburetor, according to an embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

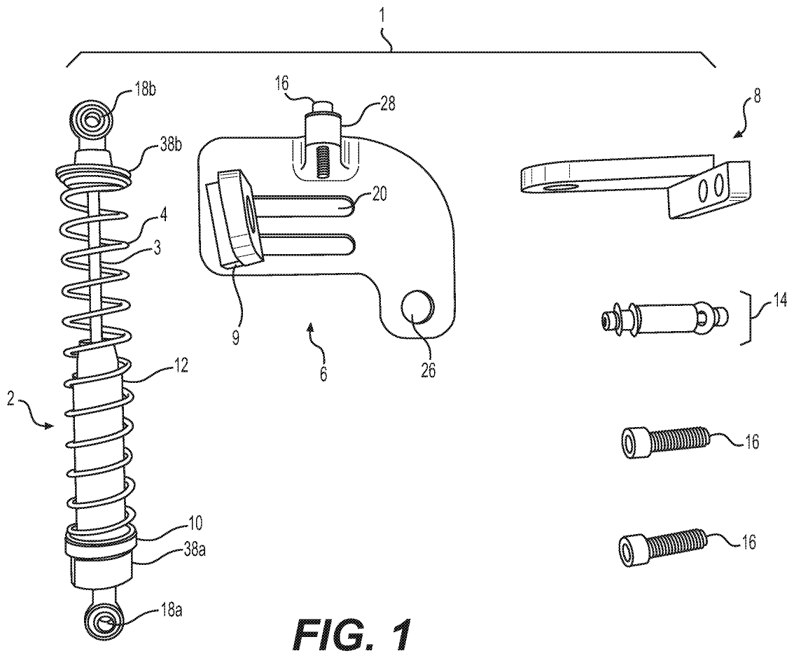

FIG. 1 illustrates the adjustable throttle return spring kit 1, according to an embodiment of the present invention. The adjustable throttle return spring kit 1 comprises an adjustable throttle return spring 2, platform 6, transmission kick down tab 8, throttle cable tab 9, spacers/bushings 14, and mounting hardware 16. The platform 6 comprises the throttle cable tab 9, mounting tab 28, channel 20 and opening 26. The mounting hardware 16 can be made of stainless steel such as 18-8 stainless steel. The spacers/bushings 14 can be made of material such as aluminum or other similar material such as mild steel, stainless steel, and titanium and can be of different lengths depending on the kit. The mounting hardware 16 can be made of stainless steel such as 18-8 stainless steel or other similar material such as mild steel, stainless steel, and titanium.

The adjustable throttle return spring 2 comprises a rod 3, spring 4, adjustable ring 10, threaded shock body 12, threaded shock body end 38a, mounting ends 18a, 18b and cap 38b. The rod 3 is one half of the adjustable throttle return spring 2 and the threaded shock body 12 is the second half. Together, the rod 3 and the threaded shock body 12 support the spring 4. The spring 4 is a compression spring. Various types of compression springs can be used. For example, various lengths, various size coils, and distance between the coils can vary. The adjustable throttle return spring kit 1 is universal because it can be installed on a variety of carburetors or fuel injection units/kits such as the Edelbrock, Holley, Quadrajet, FiTech, and Holley Sniper. In other words, the adjustable throttle return spring kit 1 can be installed on a carburetor or on an installed fuel injection unit.

The kit is universal because the size of the adjustable throttle return spring 2, bracket 5, spacers/bushings 14, and mounting hardware 16 can be changed, which allows it to mount on different size carburetors. Once the adjustable throttle return spring kit 1 is installed, the kit 1 allows the tension in the spring 4 to change without having to change the spring. 4. The tension of the spring 4 is changed by spinning the adjuster ring 10 on the threaded shock body 12 to increase or decrease preload on the spring 4. The preload can be in a range of approximately 3 pounds to 10 pounds. The length of the threaded shock body 12 can vary as long as it facilitates enough travel for full throttle. The spacers/bushings 14 allow for optional installation of cable style and create space between the carburetor 24 and adjustable throttle return spring 2. The mounting hardware 16 is screwed into the mounting tab 28 with the mounting end 18a of the adjustable throttle return spring 2.

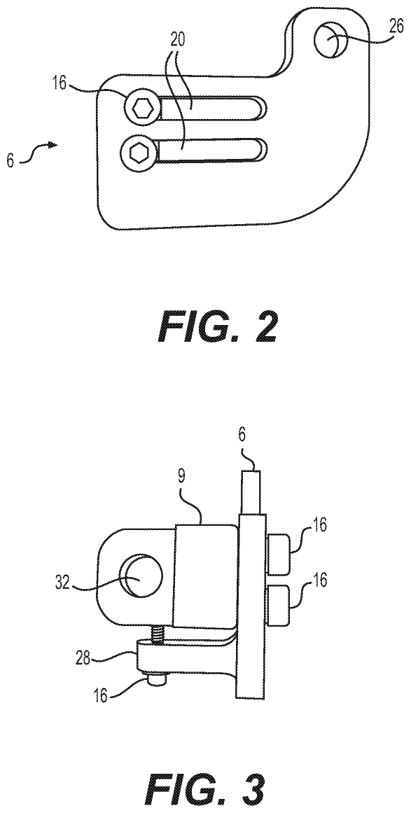

FIGS. 2-3 illustrate the platform 6, according to an embodiment of the present invention. As illustrated, the platform 6 comprises mounting hardware 16, channel 20, throttle cable tab 9, mounting tab 28 and opening 26. The throttle cable tab 9 is removably attached to the platform 6 by mounting hardware 16 and the throttle cable tab 9 comprises a cavity 32. The throttle cable tab 9 is optional. The mounting end 18 of the adjustable throttle return spring 2 mounts onto the mounting tab 28 using mounting hardware 16. The platform 6 comprises an opening 26 for a bolt 26 to connect the platform 6 to the intake manifold of the engine.

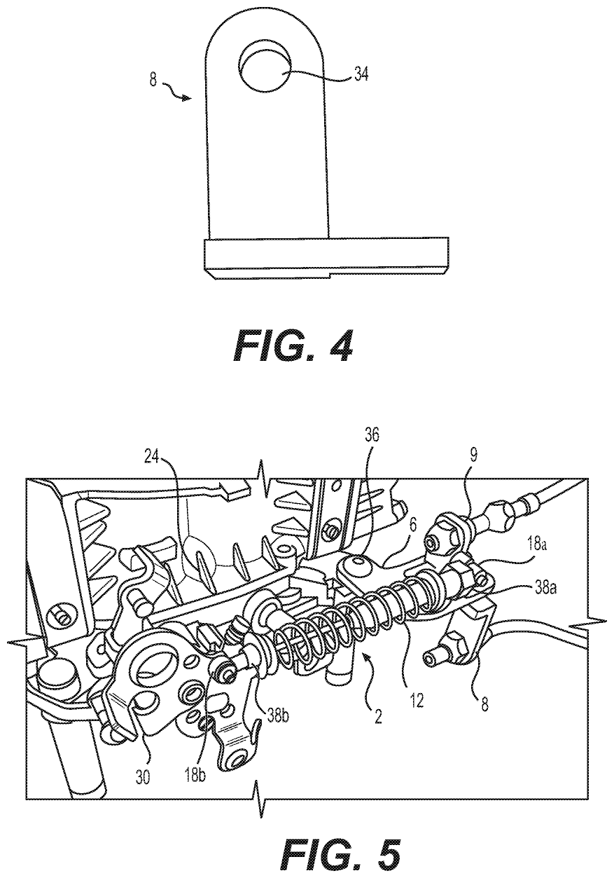

FIG. 4 illustrates the transmission kick down tab 8 comprising an aperture 34 with mounting hardware 16 and spacers/bushings 14 (not shown, see FIG. 1), according to an embodiment of the present invention. The transmission kick down tab 8 mounts to the cable attached to the carburetor. The throttle cable tab 9 and transmission kick down tab 8 are interchangeable and reversibly attach to the platform 6 and together, the components make up the bracket 5. The bracket 5 can be made of aluminum, for example, billet 6061 aluminum and can have various finishes such as clear (PLN) or black (BLK) anodized finish; however, similar materials can be contemplated. The transmission kick down tab 8 is optional and is connected to the underside of the platform 6.

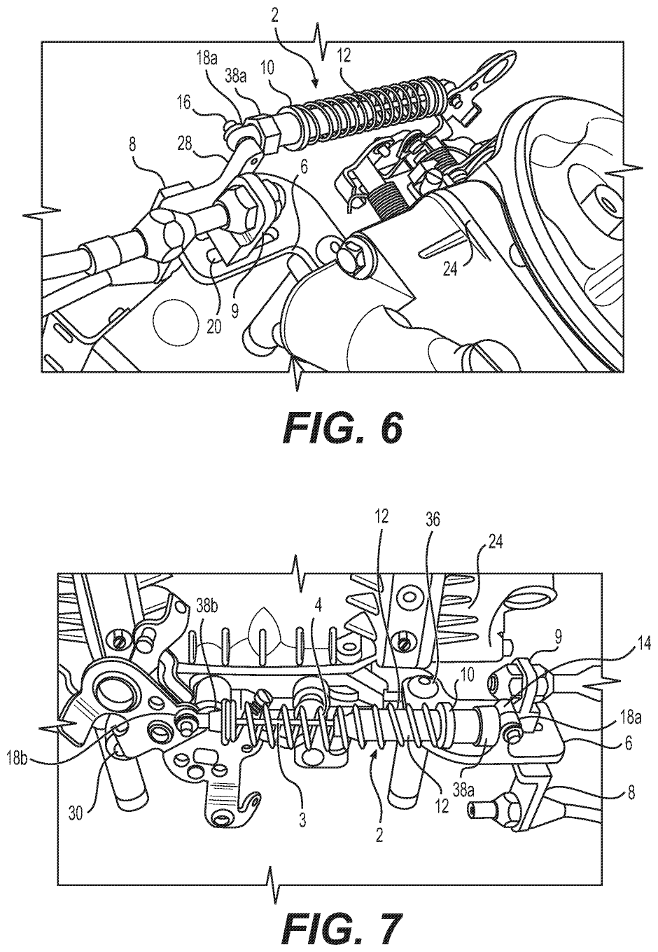

FIG. 5 illustrates various views of the adjustable throttle return spring 2 and bracket 5 mounted to the carburetor 24. As previously mentioned, the bracket 5 comprises the platform 6, transmission kick down tab 8 and throttle cable tab 9. However, the transmission kick down tab 8 and throttle cable tab 9 are optional when installing the kit 1 and the platform 6 can be used alone. The platform 6 is removably attached to the intake manifold, which is part of the engine, by a bolt 36. The mounting end 18a is removably attached to the mounting tab 28 with mounting hardware 16 (not shown, see FIG. 6). The mounting end 18b is attached to the throttle arm 30 of the carburetor using mounting hardware 16. The threaded shock body 12 can also be made of billet aluminum and can be in various colors such as clear, black, red, blue or purple as shown throughout the figures. The function of the cap 38b is to maintain the spring 3 from falling off the rod 3. The function of the threaded shock body end 38a is to mount the adjustable throttle return spring 2 to the platform 6.

FIG. 6 illustrates the adjustable throttle return spring 2, platform 6, transmission kick down tab 8 throttle cable tab 9, mounted to a carburetor 24, according to an embodiment of the present invention. As shown, the platform 6 comprises channels 20 which allow the user to adjust the location of the throttle cable tab 9 by sliding the throttle cable tab 9 and transmission kick down tab 8 along the channel 20. Adjusting the location of the throttle cable tab 9 and transmission kick down tab 8 allows the kit 1 to be used with various length cables. The throttle cable tab 9 has a cavity 32 (not shown, see FIG. 3) that allows a throttle cable to be attached. As shown, the adjustable throttle return spring 2 is attached to the mounting tab 28 by the mounting end 18a using mounting hardware 16. Adjacent to the mounting end 18a is the threaded shock body end 38a. The adjuster ring 10 can be moved along the threaded shock body 12 when the adjustable throttle return spring 2 is mounted to the carburetor 24 to change the tension of the spring without having to demount the adjustable throttle return spring 2.

FIG. 7 illustrates a top, outer side perspective view of the adjustable throttle return spring 2 and bracket 5 mounted to a carburetor 24, according to an embodiment of the present invention. Spacers/bushing 14 are used to increase the distance between the carburetor 24 and the adjustable throttle return spring 2 as some engines have car components that interfere with the installation of the adjustable throttle return spring 2. The bolt 36 attaches the bracket 5 to the carburetor 24. It is not necessary for the transmission kick down tab 8 or the throttle cable tab 9 to be used in order to mount the adjustable throttle return spring 2. The adjustable throttle return spring 2 can mount to the platform 6. Once the bracket 5 which comprises the platform 6, transmission kick down tab 8 and throttle cable tab 9 or just the platform 6 is connected to the carburetor 24 the user can include spacers/bushings 14 to adjust for the needed space. The mounting end 18a of the adjustable throttle return spring 2 is then connected to the mounting tab 28 (not shown, see FIG. 6) using mounting hardware 16. The mounting end 18b is connected to a factory hole in the throttle arm 30 of the carburetor 24 using mounting hardware 16. Once the adjustable throttle return spring 2 is mounted, the tension of the spring 4 can be adjusted by turning the adjuster ring 10 clockwise or counterclockwise along the threaded shock body 12. The cap 38b prevents the spring 4 from falling off the threaded shock body 12 and rod 3. The threaded shock body end 38a mounts the adjustable throttle return spring 2 to the bracket 5.

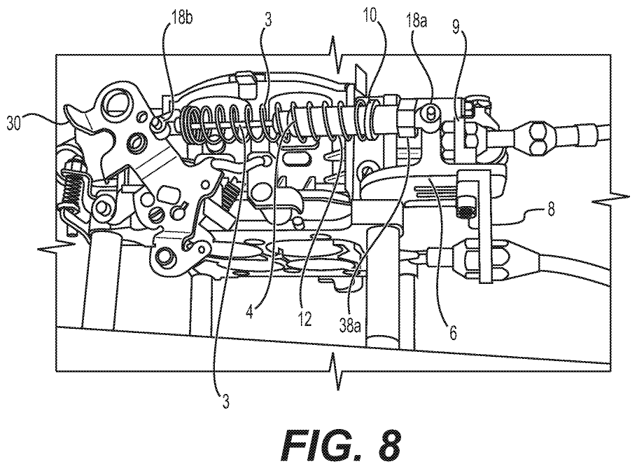

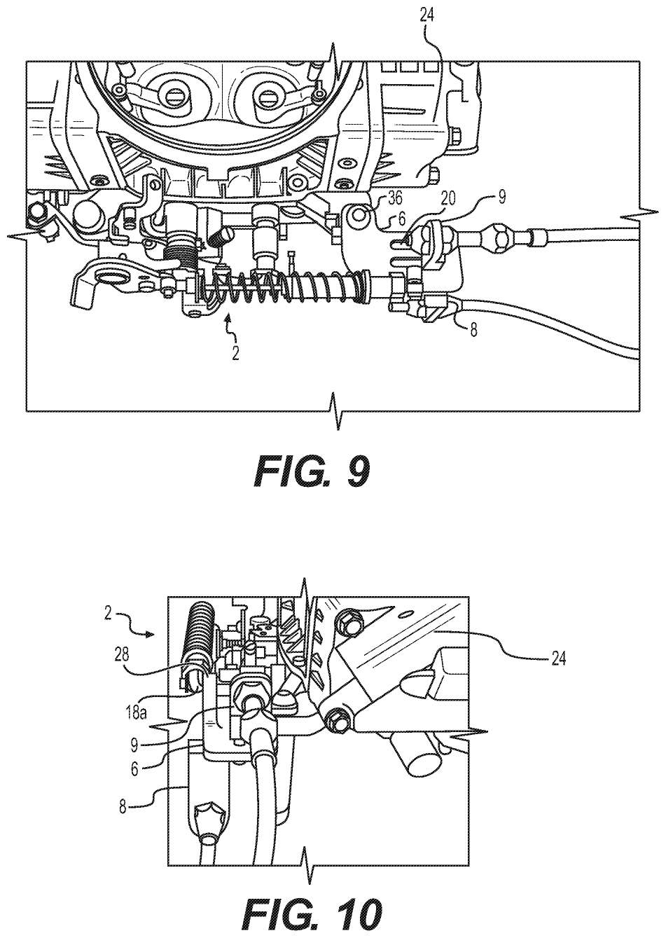

As shown in FIGS. 8-10, the kit 1 mounts the adjustable throttle return spring 2 to the exterior of the carburetor 24 using the bracket 5 and secured by a bolt 36, spacers/bushings 14 and mounting hardware 16. The mounting end 18a mounts to the mounting tab 28 and the mounting end 18b mounts to the throttle arm 30. Once installed, the tension of the throttle can be adjusted by turning the adjuster ring 10 along the threaded shock body 12 making the gas pedal softer or stiffer based on the preference. The adjuster ring 10 can be turned clockwise to make the spring 4 shorter and stiffer, thus making the gas pedal stiffer. The adjuster ring 10 can be turned counterclockwise to make the spring 4 longer and less stiff thus making the gas pedal softer. The kit 1 uses compression to operate the throttle system and is a self-contained unit with no springs to change. The spring 4 is a compression spring and the tension of the spring 4 is changed by simply adjusting the adjuster ring 10 around the threaded shock body 12 while mounted. There is no need to remove the adjustable throttle return spring 2 in order to adjust the tension. The adjustable throttle return spring 2 is safer than current systems because the spring 4 is contained in the adjustable throttle return spring 2, so if the spring 4 fails and falls off or becomes soft and overlaps onto itself, the adjustable throttle return spring 2 is still operational. The adjustable throttle return spring 2 is operational because the threaded shock body 12 and rod 3 run through the center of the spring 4 and continues to push on each other to act like a spring.

In the embodiment shown, the throttle cable tab 9 and the transmission kickdown tab 8 are set at the far right end of the channel 20 located on the platform 6. However, depending on the length of the cable, the throttle cable tab 9 and the transmission kickdown tab 8 can be slid along the channel 20 to accommodate for the different lengths. The transmission kickdown tab 8 can be located at a different location along the channel than the throttle cable tab 9. The bracket 5 can also function with only the throttle cable tab 9 or only the transmission kickdown tab 8 or with both or with neither.

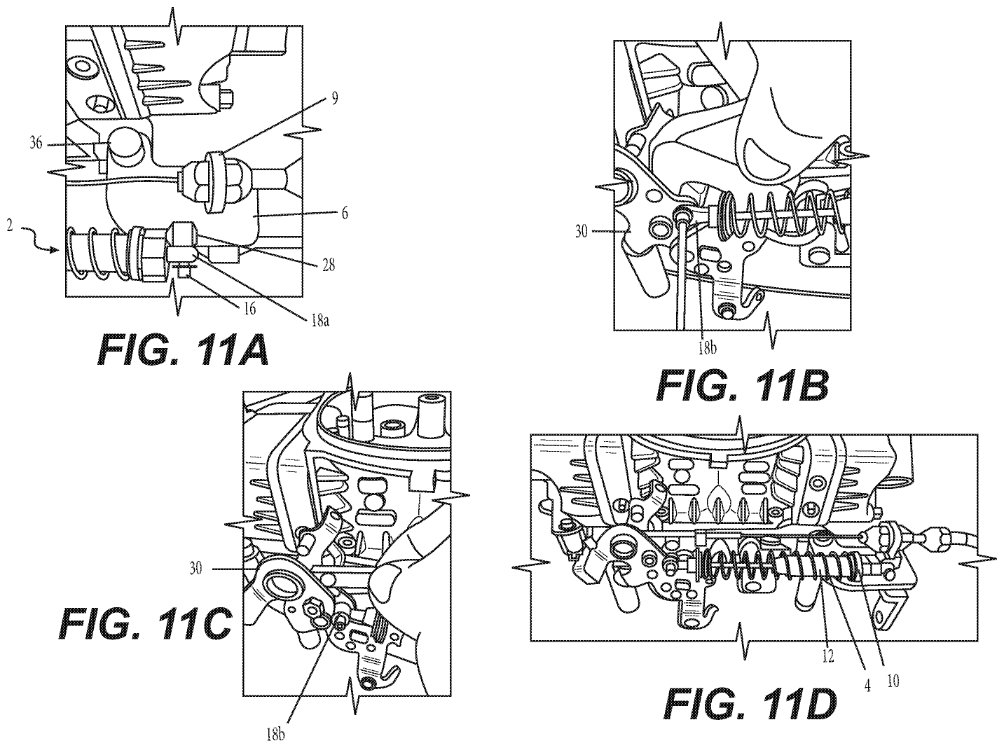

FIGS. 11A-11D illustrate a method of mounting the adjustable throttle return spring 2, bracket 5 to a carburetor 24, according to an embodiment of the present invention. The bolt 36, which bolts the carburetor to the intake manifold, the intake manifold is a part of the engine, is first removed. FIG. 11A illustrates once the bolt 36 is removed, the assembled bracket 5 comprising the throttle cable tab 9, transmission kick down tab 8 and platform 6 is installed to the intake manifold of the motor using the previously removed bolt 36. The platform 6 can be used in the kit 1 to mount the adjustable throttle return spring 2. If only the platform 6 is used, the platform 6 is attached to the intake manifold of the motor by a bolt 36 as previously described and the transmission kick down tab 8 and throttle cable tab 9 will not be attached to the platform 6. After the bracket 5 is reversibly attached to the motor, the mounting end 18a of the adjustable throttle return spring 2 is screwed into the mounting tab 28 using mounting hardware 16.

FIGS. 11B-11C, illustrates the mounting end 18b of the throttle return spring 2 reversibly mounted to the factory hole in the throttle arm 30 of the carburetor using mounting hardware 16. To operate the throttle return in the previous pull-spring system, in neutral position, the load created by the constant pulling of the throttle arm 30 (not shown, see FIG. 6) of the carburetor wears down the throttle shaft bushing because the system uses an extension spring. However, in the present preferred embodiment, when the throttle return spring 2 is in neutral position, there is no load pulling the throttle arm 30 forward against the throttle shaft bushing. The spring type used in the adjustable throttle return spring 2 is a compression spring. As such, there is no stress on the throttle shaft bushing wearing it down. Additionally, in neutral position, the throttle return spring 2 is not pushing or pulling on an object. In other words, extraneous stress on the engine components does not occur. When the accelerator pedal is stepped on, the throttle arm 30 turns in a direction toward the mounted adjustable throttle return spring 2 compressing the adjustable throttle return spring 2.

Once the throttle return spring 2 is mounted, the throttle pressure can be adjusted by shortening or lengthening the spring 4 around the threaded shock body 12. Turning the adjuster ring 10 clockwise around the threaded shock body 12, which makes the spring 4 shorter, stiffens the throttle return spring 2. Alternatively, turning the adjuster ring 10 counterclockwise around the threaded shock body 12 lengthens the spring 4, which makes the throttle return spring 2 softer.

The kit 1 can function without the transmission kick down tab 8, the throttle cable tab 9 and the spacers/bushings 14. The transmission kick down tab 8, the throttle cable tab 9 and the spacers/bushings 14 allow the kit 1 to be used with different types of carburetors 24. The transmission kick down tab 8 and the throttle cable tab 9 are interchangeable.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

What is claimed is:

1. A coil-over throttle return spring device comprising:
a rod having a first mounting end and a second mounting end;
a body located between the first mounting end and the second mounting end, and coaxially surrounding the rod;
an adjuster ring surrounding the body and configured to threadedly rotate along a length of the body; and
a throttle spring coaxially surrounding the body and rod, and loaded between the adjuster ring and a cap such that a first end of the spring abuts against the adjuster ring and a second end of the spring abuts against the cap;
wherein a compression of the spring is adjustable by rotating the adjuster ring along the body to increase or decrease a length of the spring.

2. The coil-over throttle return spring device of claim 1, wherein a length of the rod is adjustable.

3. The coil-over throttle return spring device of claim 1, wherein the first mounting end is connected to a platform on a bracket.

4. The coil-over throttle return spring device of claim 3, wherein the platform is bolted to an intake manifold of an engine.

5. The coil-over throttle return spring device of claim 1, wherein the threaded body comprises an aluminum material.

6. The coil-over throttle return spring device of claim 1, wherein the spring comprises a steel material.

7. A coil-over throttle return spring device kit comprising:
a throttle return spring device having a rod with a first mounting end and a second mounting end;
a body located between the first mounting end and the second mounting end, and coaxially surrounding the rod;
an adjuster ring surrounding the body and configured to threadedly rotate along a length of the body; and
a throttle spring coaxially surrounding the body and rod and loaded between the adjuster ring and a cap such that a first end of the spring abuts against the adjuster ring and a second end of the spring abuts against the cap;
wherein a compression of the spring is adjustable by rotating the adjuster ring along the body to increase or decrease a length of the spring; and
a bracket for attaching the first mounting end to an intake manifold of an engine, the bracket comprising
a platform having an upper side and a lower side and an opening for connecting the platform to the intake manifold;
wherein the first mounting end connects to the upperside of the platform and the second mounting end connects to a throttle arm.

8. The coil-over throttle return spring device kit from claim 7, wherein the bracket further comprises a throttle cable tab.

9. The coil-over throttle return spring device kit from claim 7, wherein the bracket further comprises a transmission kickdown tab.

10. The coil-over throttle return spring device kit from claim 8, wherein the throttle cable tab is slidable along a surface of the platform.

11. The coil-over throttle return spring device kit from claim 9, wherein the transmission kickdown tab is slidable along a surface of the platform.

12. The coil-over throttle return spring device kit from claim 7, wherein a distance between the first mounting end and the platform is adjustable.

13. The coil-over throttle return spring device kit from claim 7, wherein the bracket comprises an aluminum material.

14. The coil-over throttle return spring device kit from claim 7, wherein the body comprises an aluminum material.

15. A method of installing a coil-over throttle return spring device kit, the kit comprising
a throttle return spring device with a first mounting end and a second mounting end;
a body located between the first mounting end and the second mounting end and coaxially surrounding the rod;
an adjuster ring surrounding the body and configured to threadedly rotate along a length of the body; and
a throttle spring coaxially surrounding the body and rod and loaded between the adjuster ring and a cap;
a bracket for attaching the first mounting end to an intake manifold of an engine, the bracket comprising
a platform having an upperside and a lower side and an opening;
the method of installing the coil-over throttle return spring device kit comprising:
a) removing a bolt from the intake manifold;
b) mounting the platform to the intake manifold by securing the bolt through the opening;
c) mounting the first mounting end to the platform; and
d) mounting the second mounting end to a throttle arm.

16. A method of claim 15, further comprising attaching a throttle cable tab to the upperside of the platform.

17. A method of claim 15, further comprising attaching a transmission kickdown tab to the lower side of the platform.

18. A method of claim 15, further comprising adding a spacer between the first mounting end and the platform.

19. A method of claim 15, further comprising adding a spacer between the second mounting end and the throttle arm.

20. A method of claim 15, further comprising rotating the adjuster ring along the length of the body.
